(19) United States
(12) Patent Application Publication
(10) Pub. No.: US 2011/0295623 A1
(43) Pub. Date: Dec. 1, 2011

(54) SYSTEM AND METHOD FOR WORKERS COMPENSATION DATA PROCESSING AND TRACKING

(75) Inventors: Jill Rich Behringer, Avon, CT (US); Marlene G. Chickerella, Enfield, CT (US); JulieeAnn McCollum, Torrington, CT (US)

(73) Assignee: Hartford Fire Insurance Company, Hartford, CT (US)

(21) Appl. No.: 12/787,934

(22) Filed: May 26, 2010

(51) Int. Cl. G06Q 40/00; G06F 15/16; G10L 15/26

(52) U.S. Cl. 705/4; 704/235; 709/206; 704/E15.043

(57) ABSTRACT

The present invention relates to a workers compensation related insurance complaint management, processing and reporting system. According to some embodiments, an insurance complaint is received at a conversion system for processing. The received information may be converted to a specified format to populate an interactive web form. The web form may be augmented by various third party data sources and information may be additionally pre-filled through the conversion process. Automated complaint management reminders are generated by the system.

### FIELD OF THE INVENTION

The invention relates to the field of insurance data processing and more particularly, to the field of workers compensation data processing.

### BACKGROUND

The insurance industry is a highly regulated industry which is accountable to various state agencies and departments. In the field of workers compensation insurance, each state has its own workers compensation laws and regulations to handle claims from employees who are injured on the job. Generally, for a worker to be covered under a workers compensation policy, the injury or illness has to have occurred during the course of their employment. In the workers compensation area, various state based office and departments monitor activities and disputes related to the provision and administration of workers' compensation claims, and provide administrative and judicial services to assist in resolving disputes that arise. Accordingly, it is imperative that an insurance company track and manage complaints related to the services and products the insurance company offers for workers compensation.

A complaint can be generally defined as some verbal, electronic or written expression of dissatisfaction regarding certain decisions, products or services provided during the workers compensation process. Some examples of these workers compensation related complaints include dissatisfactions regarding the quality of care received from a doctor/nurse/therapist, questions about the lack of return to work programs offered by an employer, the non-payment of vendor bills for services rendered and other related problems. An insurance company might receive many thousands of workers compensation complaints in a single year. These complaints may be received in a variety of ways and formats such as via telephone or voicemail, through agent systems, postal mail, facsimile, text message and electronic mail. Moreover, the insurance company will typically receive many different types of documents and supporting materials such as bills, doctor reports, policies and claim forms and those documents will be received from various types of parties, e.g., claimants, employers, agents, and certain vendors.

For each complaint filed, the insurance company needs to track and mange the complaints from complaint initiation to final resolution. Moreover, various documents associated with the complaint may need to be collected together in order to be processed in an orderly fashion. Such actions can be time consuming, error prone, and difficult to administer on a cost effective basis, especially when a substantial numbers of documents and insurance claim complaints are involved. Additionally, the resolution progress and outcome of each and every complaint needs to be tracked and reported both from an insurance company compliance and regulatory perspective. These requirements place a large administrative and financial burden on the insurance companies. Large numbers of unresolved complaints can also quickly lead to customer dissatisfaction and loss of current and future revenue for an insurer as poor workers compensation claims experiences can cascade into negative public perceptions in the marketplace. Accordingly, it would be desirable to have an improved and efficient system for the processing, tracking and managing of these workers compensation related complaints.

### SUMMARY OF THE INVENTION

The present invention is a workers compensation complaint tracking system for facilitating resolution of workers compensation related complaints comprising a database server implemented in at least one processor, at least one storage device; a complaint intake module configured to display a dynamic intake form for receiving and capturing complaint data and for storing said data in said storage device; a validation engine for validating the complaint information in conjunction with one or more complaint validation rules; and a reporting module configured to furnish reports of the validated complaints for at least one of regulatory compliance and internal insurance company guidelines; wherein each of said modules is configured for execution on the server and access by one or more remote users.

In one embodiment, the present invention is a workers compensation complaint processing system comprising a communication device to receive and transmit complaint data via a communication network; a processor coupled to the communication device for processing complaint related information; and a storage device in communication with said processor and storing instructions adapted to be executed by said processor to provide a complaint input form for receiving complaint related information; process insurance complaint information into an electronic data format; store the insurance complaint electronic data; validate the data with one or more validation rules; augment the data with additional data associated with the processed data; and transmit at least one status message related to the complaint related information.

In one embodiment, the present invention is a computer-readable medium storing instructions adapted to be executed by a processor to perform an insurance complaint processing method in a workers compensation complaint tracking system, said method comprising receiving insurance complaint information via an intelligent web form rendered on a communication device, validating the complaint information based on one or more business rules to determine if the complaint information qualifies for tracking; augmenting the validated complaint information in the intelligent web form with data related to the complaint information; tracking resolution progress of the complaint based on date based milestones in the intelligent web form; and transmitting an electronic indication of the resolution progress to at least one other communication device.

In one embodiment, the present invention is a computerized method for processing workers compensation related complaints, the method comprising: receiving insurance complaint information via an intelligent web form having a plurality of dynamic input fields rendered on a communication device, pre-populating one or more of the dynamic input fields based on one or more of historical complaint related data and employer policy data; and generating one or more electronic reminder messages related to resolution progress of the complaint.

A technical effect of the invention is an automated facilitation of workers compensation insurance complaint information management, imaging, processing and tracking in an expedited and efficient manner which benefits injured workers, workers compensation vendors and insurance company entities. With this and other advantages and features that will become hereinafter apparent, a more complete understanding of the nature of the invention can be obtained by referring to the following detailed description and to the drawings appended hereto.

### BRIEF DESCRIPTION OF THE DRAWINGS

FIG. 1 is block diagram of a system according to some embodiments of the present invention.

FIG. 2 is block diagram of a system according to some embodiments of the present invention.

FIG. 3 illustrates a method according to some embodiments of the present invention.

FIG. 4 illustrates a system display in accordance with some embodiments of the invention.

FIG. 5 illustrates a system display in accordance with some embodiments of the invention.

FIG. 6 illustrates a system display in accordance with some embodiments of the invention.

FIG. 7 illustrates a system display in accordance with some embodiments of the invention.

FIG. 8 illustrates a dynamic system display interacting with one or more third party sources in accordance with some embodiments of the invention.

FIG. 9 is block diagram of a complaint processing system in accordance with some embodiments of the invention.

FIG. 10 is block diagram of a complaint processing system in accordance with some embodiments of the invention.

FIG. 11 illustrates a method according to some embodiments of the invention.

FIG. 12 illustrates an exemplary resolution workflow according to some embodiments of the invention.

FIG. 13 illustrates an exemplary reporting output according to some embodiments of the invention.

### DETAILED DESCRIPTION

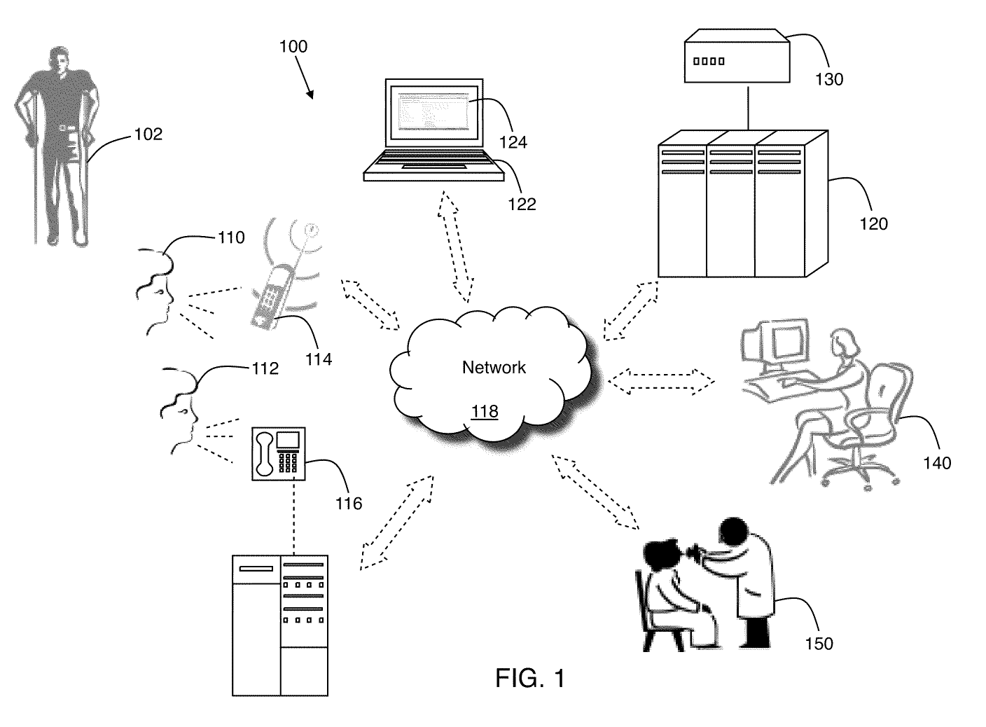

FIG. 1 shows a block diagram of an insurance complaint document management, tracking and processing system 100 according to some embodiments of the present invention. System 100 facilitates the management, tracking and processing of insurance related complaint documents that are received from a variety of sources and data feeds to speed resolution of the complaints. In the highly regulated insurance industry, complaints and the resolution of such complaints need to be accurately managed and tracked as accountability for such resolution may be mandated by certain regulations and rules overseen by a variety of government agencies or trade associations such as a Department of Insurance, Better Business Bureau and/or a state Department of Worker's Compensation office. Efficient and expedient tracking and management of complaints allows insurers to identify trends in service defects, track the implementation of corrective actions, measure performance improvement, and apply additional remedies as necessary throughout the workers compensation process. The complaint data may be further used for internal applications such as complying with internal procedures and guidelines specific to each insurer and for underwriting applications such as using complaint related information to verify coverages, premiums and/or discounts being given to a certain employer.

Many times complaints may be received from and/or be related to certain vendors or contractors in the workers compensation such as doctors, nurses, therapists and pharmacists. One illustrative example of a complaint that is processed and tracked by the system may relate to a complaint from a patient who was injured on the job regarding the medical quality of care he or she received for the injury or condition such as if the patient was discharged inappropriately from the treating hospital. Proper and expedited resolution of these complaints can include a variety of outcomes based on insurance company policy, contract considerations and regulatory mandate.

As used herein, the terms “complaint message” or “complaint document” may refer to, for example, electronic, verbal or physical representations of information and data associated with a complaint or dispute related to an insurance policy, event, or claim. By way of further example, an insurance complaint document may be an electronic mail, voicemail or voice message from one or more third parties such as a workers compensation related provider or vendor, a billing document (e.g., from medical service provider), and/or an insurance policy document (e.g., such as a workers compensation policy). Additionally note that the word “document” as used herein can refer to other types of information, including photographs, video images, and/or audio recordings associated with an insurance event or claim. System 100 may be employed by one or more insurance companies or by one or more third party administrators for management, tracking and processing complaints of one or more other insurance companies.

Moreover, as used herein the terms “party” and “participant” may refer to any person or entity that is directly or peripherally involved in an insurance workers compensation matter. By way of example only, a party or a participant could be an injured worker, a doctor or nurse treating the injured worker, a vendor such as a pharmacy providing medicine to the injured worker, a representative from a Department of Insurance office, a State Attorney General, a local or national business association such as the Better Business Bureau, an individual insurance claimant, an attorney or law firm, a broker or agent, a third party service provider, or an insurance company employee or contractor.

Still referring to FIG. 1 a block diagram of the software and hardware components of a simplified network computing system environment 100 of the present invention is shown for the intake, tracking and processing of workers compensation related complaints. Such complaints generally related to one or more injured worker(s) 102 who have been injured during the course of their employment. System 100 includes one or more parties/complainants 110 and 112 who communicate via one or more participant devices 114 and 116 regarding one or more workers compensation related complaints. Parties 110 and 112 generally have some personal or professional affiliation or relation to injured worker 102, such as the injured worker's relative, their employer, their doctor, their pharmacist, etc. Communication of the complaints may be accomplished via a network 118 which is in communication with an insurance company affiliated server 120. Network 118 may be one or a combination of a Local Area Network (LAN), a Metropolitan Area Network (MAN), a Wide Area Network (WAN), a proprietary network, a Public Switched Telephone Network (PSTN), a Wireless Application Protocol (WAP) network, a Bluetooth network, a wireless LAN network, and/or an Internet Protocol (IP) network such as the Internet, an intranet, or an extranet. Note that any devices described herein may communicate via one or more such communication networks.

Referring still to FIG. 1, server 120 may include one or more applications or server-side application code for communicating with an insurance company affiliated terminal(s) or workstation(s) 122 being operated by one or more insurance company employees and/or contractors for the intake, processing and management of the complaints. Server 120 may be a Web server which delivers web pages, markup documents and/or electronic messages generated by the server side application code to user(s) operating terminal(s) or workstation(s) 122. Server 120, as discussed in more detail later herein, provides a dynamic input form 124 for the intake and collection of complaint related information provided by parties 110 and 112.

Server 120 is further coupled to one or more database(s) 130, in accordance with embodiments of the present invention. Database(s) 130 stores current and historical complaint information and may include a database management system (DBMS) software of a relational database type, such as a DB2 universal database product provided by International Business Machines Corporation, an Access product provided by Microsoft Corporation or an Oracle Database product provided by Oracle Corporation for storing and processing information related to workers compensation related complaint information in the present invention. In one embodiment, the database server 130 may also provide certain database query functions such as generation of structured query language (SQL) in real time to access and manipulate the data. Server 120 may also include a real time, bidirectional, reliable messaging application to transmit messages to one or more complaint handler(s) 140 and one or more workers compensation related vendor(s) 150, such as a doctor or nurse, over network 118. In the present invention, messages may include reminder voice mail, text and/or electronic mail message such as electronic mail messages based on one or more of the messaging protocols including IMAP, POP3, MIME and SMTP for alerting one or more participants as to the initiation, status and progress of one or more workers compensation complaints. In the present invention, handler(s) 140 may be an individual or entity affiliated or connected with an insurance entity for the handling of the workers compensation related complaint, such as may be known as a Designated Complaint Intake Coordinator (DCIC).

The present invention provides benefits to a number of parties such as an insurance company, the insurance company employees, workers compensation vendors and injured claimants. For example, an insurance company employee who uses the system benefits from an easier to use, more intuitive and streamlined system resulting in increased productivity and worker satisfaction. The insurance organization will benefit from enhanced customer service, greater regulatory compliance and improvement in vendor performance. Injured workers will benefit from improved quality of service and care and their employers will improve as the injured worker's recovery time and eventual return to work will be accelerated.

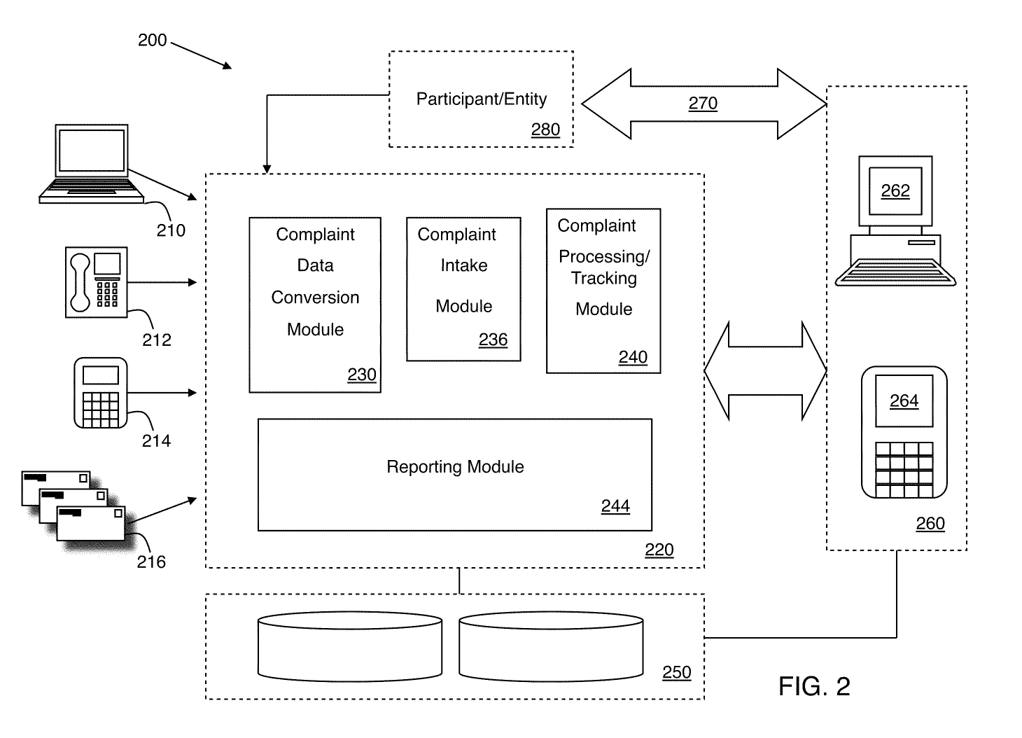

Referring now to FIG. 2, an embodiment of a system 200 for intaking, tracking and processing workers compensation related complaints is shown. In system 200, one or more participants might send, provide or deliver insurance complaint information and/or documentation from one or more remote devices 210, 212, and 214 via a communication network, such as network 118 shown in FIG. 1. Devices 210, 212, and 214 may comprise, for example, handheld electronic devices, telephones, facsimile machines, email servers, and/or other transmission device. Note that any of the devices described herein might comprise a Personal Computer (PC), a portable computing device such as a Personal Digital Assistant (PDA) or smart-phone type device, or any other appropriate storage and/or communication device to exchange complaint related information. According to some embodiments, participants might also send workers compensation related complaint documents 216 to the system via postal mail or any other document delivery system. For example, all mail addressed to a particular Post Office box might be delivered to, and be scanned in by, the system 200.

According to some embodiments, the insurance complaint documents provided by participants and/or the remote devices is received by or at a server 220 which may include a complaint data conversion module 230, a complaint intake module 236, a complaint processing module 240 and an intelligent reporting module 244. The complaint data conversion module 230 may, for example, convert each received message or document into a specified document image format (e.g., an electronic file representing the insurance complaint message or document). Complaint data conversion system 230 may also perform automatic speech recognition for voice based calls and messages to convert the speech into text for input into the system. The complaint conversion system 230 may also assign complaint document or correspondence identification data to the document image. For example, conversion system 230 might assign a unique identifier, such as some alphanumeric indicia related to certain complaint identifying indicia such as a source of the complaint (employer, individual, government entity or agency, etc.), a claimant name, an address, and/or date of loss to the document image. The unique identifier may also identify a specific insurance company for use by a third party administrator to segregate different insurance companies' complaints.

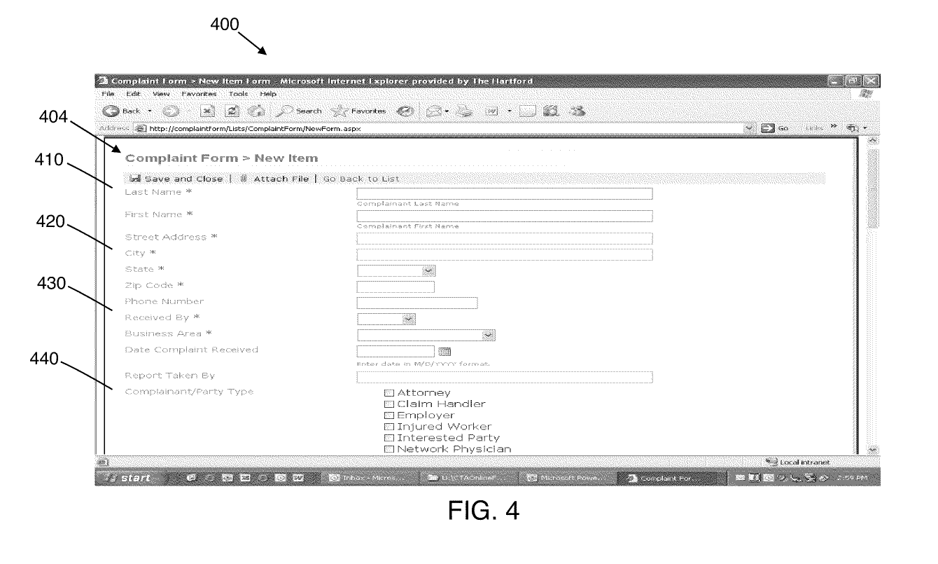

The data conversion system 230 interfaces with a complaint intake module 236, automated complaint processing/tracking module 240 and intelligent reporting module 244. Complaint intake module 236 provides a dynamic graphical user interface using one or more dynamic Web forms to intake workers compensation related information as discussed in more detail later herein with respect to FIGS. 4-9. The automated complaint processing/tracking module 240 in a preferred embodiment would match and validate the complaint data in view of certain business and/or regulatory rules such as rules governing the response time for a certain type of complaint. Complaint processing/tracking module 240 module may also track the complaint data with appropriate identifying indicia such as an employer identifier, insurance policy number, insurance event number, and/or insurance claim number which may be resident in database server 250 or from one or more internal and/or external data sources. Policy tracking is critical in the complaint management process so that complaint resolution can be associated with the appropriate employer, claimant and/or policy claim at issue.

According to some embodiments, the automated complaint processing/tracking module 240 may also perform a redundancy review. As used herein, the term “redundant complaint” refers to two or more complaints which are associated with the same employer/employee/insurance policy and/or policy claim. It is contemplated that one or more participants may provide the same or similar complaints across a variety of mediums, formats and submission venues. Similarly, a single complainant may submit the same complaint via two different mediums such as via postal mail as well as via email. Consolidating redundant complaints that may have been made greatly reduces the administrative and resource burden on insurance companies and their employees and agents. This may be accomplished by a review of the document image, the insurance information, and/or the document identification data and comparing this information with one or more other document images to resolve redundancies. Redundant complaints can result in duplicative and inefficient processing of the complaints to resolution. For example, if two redundant complaints are resolved independently of one another, the result may be two different resolutions affecting the same policyholder. Furthermore, supporting documentation in one redundant complaint may be able to assist resolution in another related redundant complaint. Once multiple redundant complaints are identified, a single complaint record or file may be created which is associated with a single insurance policy or claim with the insurance company.

Note that complaint document conversion module 230, complaint intake module 236, automated claim processing module 240 and intelligent reporting module 244 and/or any of the other devices described herein might communicate directly such as via a network communication system, via an email message attachment or a file transfer or through one or more database(s) 250. For example, the complaint document conversion system 230 might store an image file (or a link or pointer to the image file) in database(s) 250. The claim processing module 240 could then access the image file via database(s) 250. Database(s) 250 may also store related employer information, employee information, policyholder information, historical complaint document information and other insurance related information as needed by complaint document conversion system 230, complaint intake module 236 and claim processing/tracking module 240.

According to some embodiments, complaint document conversion module 230, complaint intake module 236, complaint processing/tracking module 240 and intelligent reporting module 244 may be coupled to a remote complaint resolution processing sub-system 260 which may include one or more local or remote field office or third party administrator claim processor devices 262, 264. For example, an employee of an insurance company might review the complaint file and associated insurance information (e.g., from the databases 250) when handling one or more of the complaint file for resolution. Referring still to FIG. 2, complaint processing sub-system 260 is in communication via communications link 270 with a participant/entity 280 which may be one or more of an insurance company, a vendor such as a doctor, therapist or a pharmacy and/or a regulation type entity such as a department of insurance or office of workers compensation for communication of complaint related information such as resolution progress information.

Referring still to FIG. 2, any number of participant devices and claim processor devices (and any other devices described herein) may be included and/or combined according to embodiments of the present invention. For example, in some embodiments, server 220 and database 250 might be co-located and/or may comprise a single apparatus or sub-system. In the present invention, one or more of data conversion, complaint intake and tracking processes may also be implemented as integrated or stand-alone modules. For example, a conversion module may be implemented as an intelligent hardware component incorporating circuitry comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like. Modules may also be implemented in software for execution by various types of computer processors. A module of executable code may, for instance, comprise one or more physical or logical blocks of computer instructions which may, for instance, be organized as an object, procedure, process or function. Nevertheless, the executables of an identified module need not be physically located together, but may comprise separate instructions stored in different locations which, when joined logically together, comprise the module and achieve the stated purpose for the module such as implementing the business rules logic prescribed by system 200. In the present invention a module of executable code may be a compilation of many instructions, and may even be distributed over several different code partitions or segments, among different programs, and across several devices. Similarly, complaint data may be identified and illustrated herein within modules, and may be embodied in any suitable form and organized within any suitable type of data structure. Such data may be collected as a single data set, or may be distributed over different locations including over different storage devices, and may exist, at least partially, merely as electronic signals on a system and/or network as shown and describe herein.

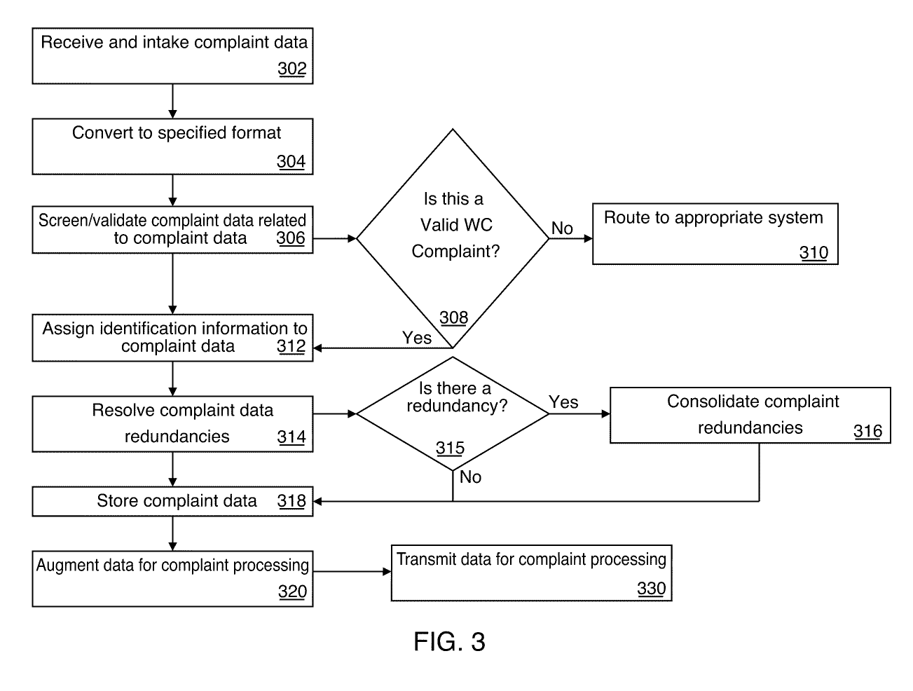

FIG. 3 illustrates a method that might be performed, for example, by some or all of the components of systems 100 and 200 described with respect to FIGS. 1 and 2 according to some embodiments. The flow charts described herein do not imply a fixed order to the steps, and embodiments of the present invention may be practiced in any order that is practicable. Note that any of the methods described herein may be performed by hardware, software, or any combination of these approaches. For example, a storage medium may store thereon instructions that when executed by a machine result in performance according to any of the embodiments described herein.

At step 302, an insurance complaint call, message or document is received at a complaint document processing system such as may be provided via server 220 shown in FIG. 2. Generally, the complaint processing system might receive and log thousands of telephone calls, emails, voicemails and other insurance complaint documents from various participants and sources each day. Generally, internal or third party claim staff related to the insurance company will attempt to resolve a complaint verbally, but if the complaint is not resolved, complaint related data then is input in the present system for processing. Staff handling intake of the complaint may be complaint intake coordinators associated with an insurance company or third party administrator staff who handle complaints for one or more insurance companies.

At step 304, to the extent necessary, the received call, message or complaint document may be converted into a specified format. For example, an automated application at document conversion system 230 shown in FIG. 2 might translate received facsimile based signals into an electronic image file or a voice message or telephone conversation may be converted into text through an Automatic Speech Recognition (ASR) facility or module. For example, an ASR module may take a digitized audio signal of an utterance, such as speech, as input and provides the corresponding text transcription of the audio signal as output for capture and storage by system 200 shown in FIG. 2. In some embodiments, the recognition is achieved by taking discrete samples of the speech, converting them to certain vectors that represent a speech segment, and mapping sequences of these vectors to possible sequences or concatenations of text units, words or phrases. The system then associates a probability or likelihood to text unit sequences given a sequence of certain vectors, depending on how well the units correspond to the feature vectors. The particular sequence of text units having the highest probability is then determined to be the most probable textual transcription of the speech or feature vector sequence. In other cases, paper based complaint documents might be scanned and converted via an Optical Character Recognition (OCR) process into image files with text recognition. Electronic submissions may be processed to convert the complaint submission into a specified format for storage in one or more databases.

At step 306, the document identification data is screened/validated to determine if the complaint is valid for processing and tracking by the present system, step 308. Screening validation can be accomplished by the DCIC or by way of intelligent automated processing such as keyword scoring, contextual keyword sorting, semantic sorting, metadata scoring, or other data mining algorithms. Certain types or sources of complaints will be screened out, excluded, and routed to an alternate system, at step 310. For example, generally all complaints originating out of the Department of Insurance (DOI) and Department of Workers' Compensation (DWC) are re-routed to certain insurance field office systems for proper handling.

At step 312, complaint identification data is assigned to the complaint. The complaint identification data may be an alphanumerical identifier and include identifying indicia such as a date initiated, employer name, claim number, a claimant name, address, and/or contact information. Other examples of policy identification data might include a date of complaint, a date of loss or accident, a date of treatment, a claim type, and/or a geographic location (e.g., a state where an insurance policy was issued or where an insurance claim arose). The assignment of policy identification data helps assist in tracking and management of the complaint and any subsequent resolution.

At step 314, complaint redundancies are resolved by determining, at step 315 if a redundancy exists. For example, an each individual complaint may be cross-referenced with an aggregate set of historical complaint documents to determine if one or more redundancies exist. If redundancies are found, the complaint documents are consolidated 316. Removing redundancies eases the burden on the insurance company complaint resolution process since duplicate complaints are not processed and tracked resulting in wasted resources.

At step 318, complaint documents are stored in an electronic repository such as in one or more local or remote database(s), such as database 250 as described in FIG. 2. Stored complaint documents can form a repository for data mining for both data validation, pre-populating future complaint forms, fraud detection, compliance requirements and other purposes.

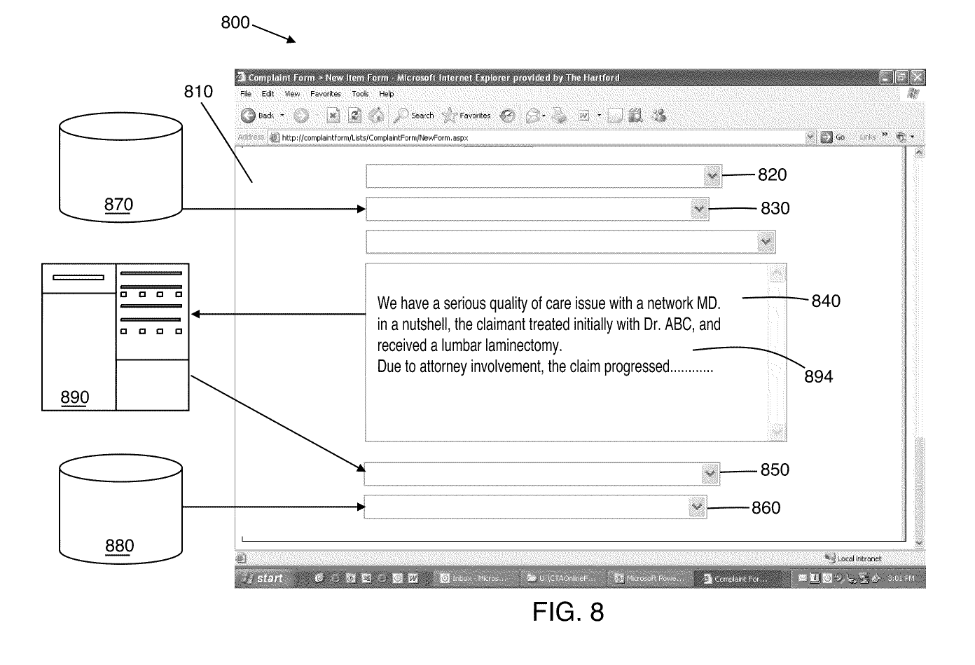

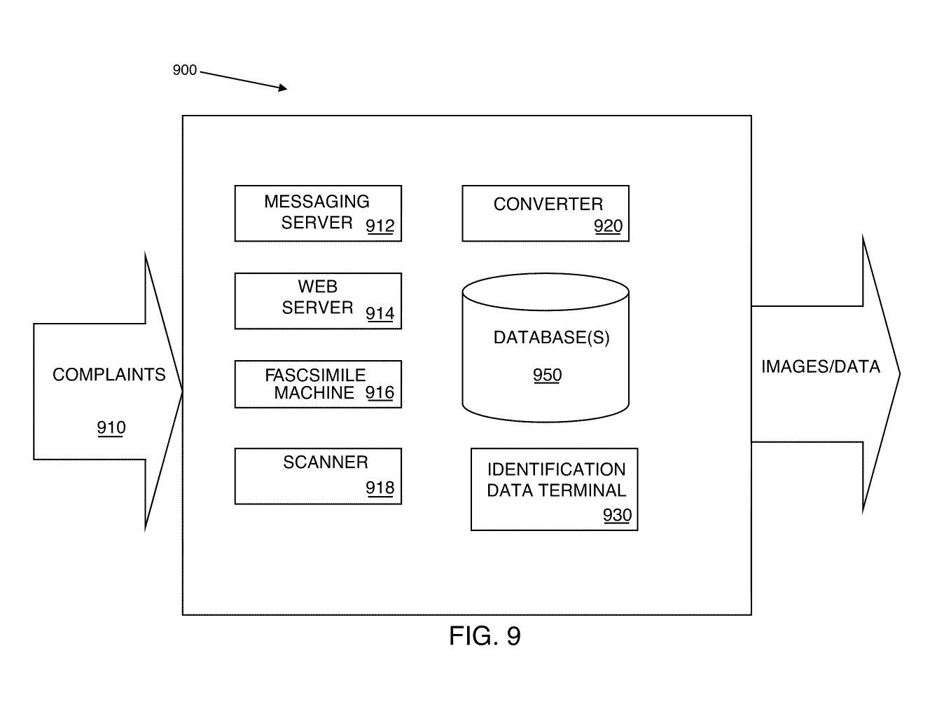

At step 320, complaint data is augmented via one or more data processors and databases as will be discussed in more detail later herein with respect to FIGS. 8 and 9. Augmentation or supplementation may occur based on the inputted complaint information which is dynamically augmented using intelligent historical data mining, through use of predictive data modeling and by other methods for supplementing data in real time. For example, augmentation may include using an inputted injured worker name to cross reference with a third party address database to pre-fill one or more fields of the complaint input form.

At step 330, complaint data is transmitted to one or more participants, such as to a workers compensation vendor, the complainant, and/or complaint resolution processors which may be associated with an insurance company and may be comprised of an individual or coordinator of complaints identified in each company or office. Reminders may be sent via step 330 to assist complaint processors in resolving the complaint in one or more manners in accordance with the circumstances of the policy underlying the complaint and appropriate regulatory guidelines. Complaint progress and/or resolution may also be communicated to the appropriate regulatory agency or employer as is necessary via data transmission step 330.

FIG. 4 illustrates an exemplary graphical user interface display in accordance with an exemplary embodiment of the present invention. In particular, FIG. 4 illustrates a display 400 that might be used, for example, to input complaint information about one or more workers compensation related complaints. Display 400 may be rendered by server 120 such as described with respect to FIG. 1. The display 400 includes an electronic web based computer form 404 that has been configured to display information for inputting complaint related information such as the name of the complainant 410, their address information 420, and how the complaint was received such as via phone, written or verbal 430. It is also contemplated that one or more fields of display 400 may be pre-populated or pre-filled in real time from one or more processors and databases or data sources. In one embodiment, the selection of “phone” or “verbal” in field 430 may trigger a speech to text process as discussed with respect to FIG. 2, the results of which are used to automatically populate one or more fields of form 404 from a stored voicemail or audio file related to the complaint being input. Additional input fields may be provided in form 404 such as complainant/party type 440 for input which will provide the eventual complaint handler/processor additional information about the complaint to help in expediting resolution.

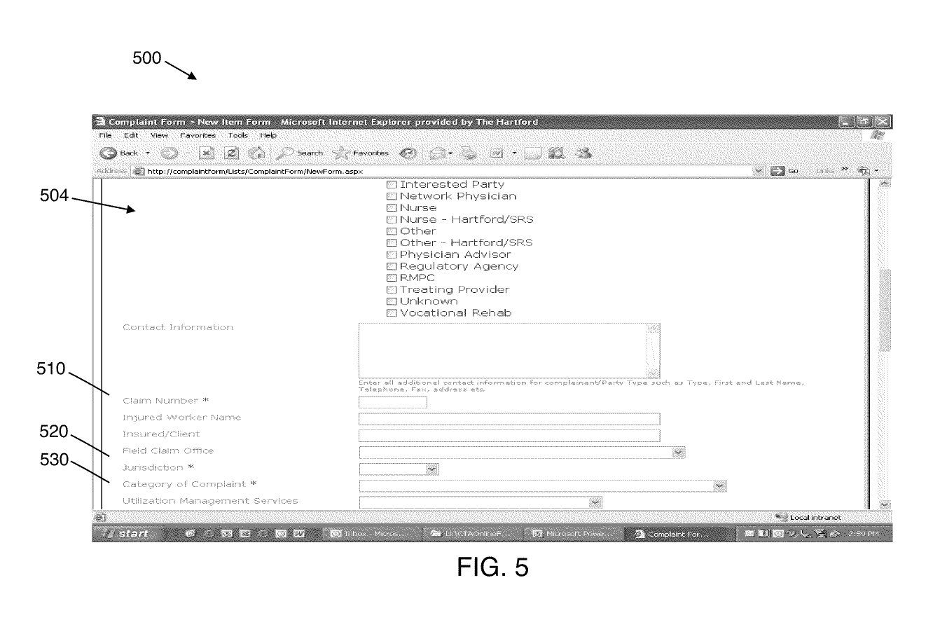

FIG. 5 illustrates an exemplary graphical user interface display 500 which is related to display 400 shown in FIG. 4 in accordance with an exemplary embodiment of the present invention. In the present invention, a user of the system may, according to some embodiments, adjust and/or enter additional information about each of the entries in form 504 such as in input fields 510, 520 and 530. Field 510 may accept input of a related claim number, field 520 may accept input of a jurisdiction such as a state or locale and field 530 may accept input of a category of the complaint, such as quality of care, fee disputes, health care providers contracts, etc. It is contemplated that one or more of the input fields may be provided as drop down type menus or other facilities for restricting inputs to certain pre-determined choices for the user. For example, the following exemplary script/markup language may be used when providing such a drop down type menu for field 530 which may be coded as follows for providing various choices for specifying the “Category of Complaint” type:

<SCRIPT>fld = new ChoiceField
(frm,“Category_x0020_of_x0020_Complain”,“Category of Complaint”,“”);
fld.format = “Dropdown”;
fld.AddChoice(“Administrative”, “”);fld.AddChoice(“Case Management
Services”, “”);fld.AddChoice(“Claim Management Services”,
“”);fld.AddChoice(“Medical Bill Processing”, “”);fld.AddChoice(“Network
Services”, “”);fld.AddChoice(“Quality of Medical Care”,
“”);fld.AddChoice(“TX - HCN quality of care or services”,
“”);fld.AddChoice(“TX - HCN accessibility and availability of services or
providers”, “”);fld.AddChoice(“TX - HCN utilization review and retrospective
review, as applicable”, “”);fld.AddChoice(“TX - HCN complaint
procedures;”, “”);fld.AddChoice(“TX - HCN health care provider contracts”,
“”);fld.AddChoice(“TX - HCN bill payment, as applicable”,
“”);fld.AddChoice(“TX - HCN fee disputes;”, “”);fld.AddChoice(“TX - HCN
miscellaneous.”, “”);fld.AddChoice(“UM -Appeal Determination”,
“”);fld.AddChoice(“UM - Customer Service”, “”);fld.AddChoice(“UM -
Physician Advisor”, “”);fld.AddChoice(“UM - Turnaround Time for Review
Determination”, “”);fld.AddChoice(“UM - Written Notice”,
“”);fld.AddChoice(“Other”, “”);fld.fRequired =
true;fld.IMEMode=“”;fld.BuildUI( );</SCRIPT>

The foregoing functionality may be implemented using Hypertext Markup Language (HTML), as well as its derivatives such as DTML, XML, DHTML, etc. Different versions of such language may support not only text, multimedia, and hyperlink features but also calls to embedded or external scripts or programs. Similarly, the software elements of the present invention may also be implemented with any programming or scripting language such as C, C++, Java, COBOL, Javscript, assembler, PERL, or the like, with the various algorithms being implemented with any combination of data structures, objects, processes, routines or other programming elements and code. Generally, when a user, via a browser type software, contacts a web site for example, using a URL such as http://complaintform/Lists/ComplaintForm/NewForm.aspx, and requests download of content, what is transferred over the network from the web server will be code and data, which the browser then interprets to generate form 504 within display 500.

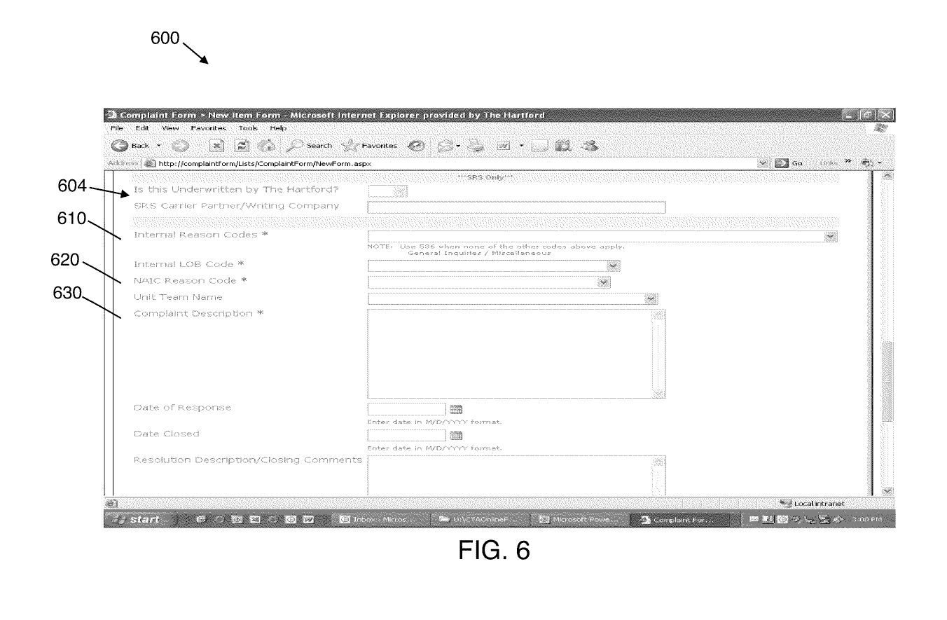

FIG. 6 illustrates an exemplary graphical user interface display 600 which is related to displays 400 and 500 shown in FIGS. 4 and 5 in accordance with an exemplary embodiment of the present invention. Display 600 includes a form 604 with additional input field 610, 620 and 630. Field 610 may be configured to accept input related to certain internal reason codes such as “Chiropractic complaint”, “Claim staff discourteous or uncooperative”, “Claim staff questions the medical provider decision”, “Complaint against non-contracted vendor”, “Complaint concerning access to chiropractic provider” and “Data Integrity” by way of non-limiting examples. Field 620 may accept input of other reason codes such as “Delays”, “Unsatisfactory Settlement” and “Denial of Claim.” Field 630 may accept input of information related to a complaint description in the form of a free text field which may be input by a user of the system and/or partially or completely populated via recognition or scanning processes as discussed earlier herein.

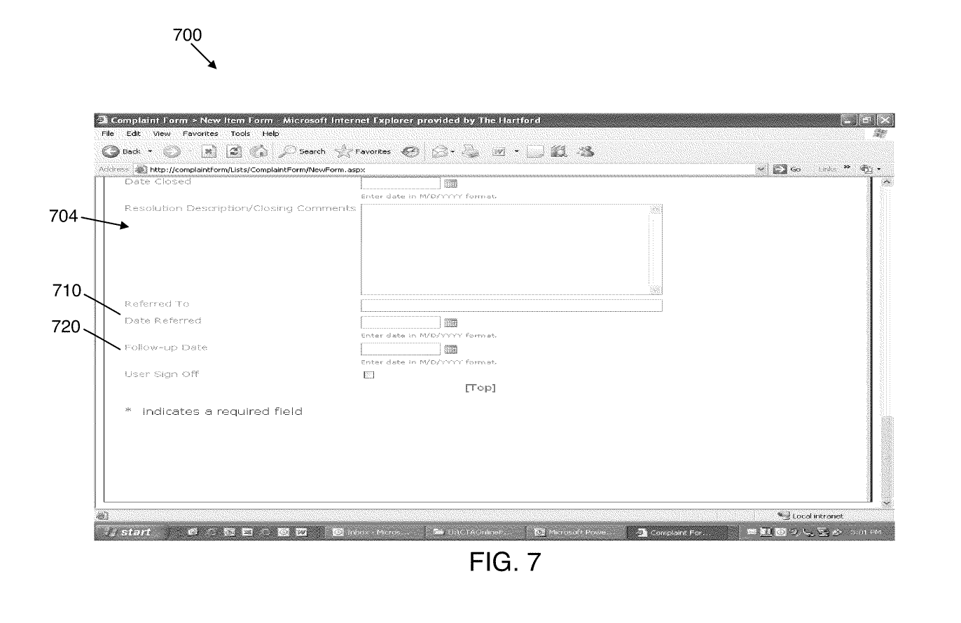

FIG. 7 illustrates an exemplary graphical user interface display 700 which is related to displays 400, 500 and 600 shown in FIGS. 4-6 in accordance with an exemplary embodiment of the present invention. Display 700 includes a form 704 which includes exemplary input fields 710 and 720. Field 710 captures date based information such as for a referral date which relates to the date which the complaint was sent for resolution follow up through one or more resolution workflows, such as managed by DCIC personnel. Field 720 captures a follow up date which indicates when additional resolution related activities are accomplished or scheduled to be accomplished with respect to the underlying complaint. In one embodiment, the user may enter the date by selecting field 720 and typing in a date within a free form field or a field restricted to date formatted input such as xx/yy/zzzz. Additionally, form 704 may be configured to display a small calendar icon next to a date input field and when the user selects or clicks on this calendar icon, some portion of a calendar is displayed and the user can select a desired date by “clicking” on the desired portion of the displayed calendar. Each day in the displayed calendar would encompass an independent data selection field of its own for input through form 704. In the present invention, these dates provided may be linked to one or more resolution process workflows and as such may trigger one or more reminder messages, voicemail and/or electronic mail message, such as may be provided via server 130 shown in FIG. 1.

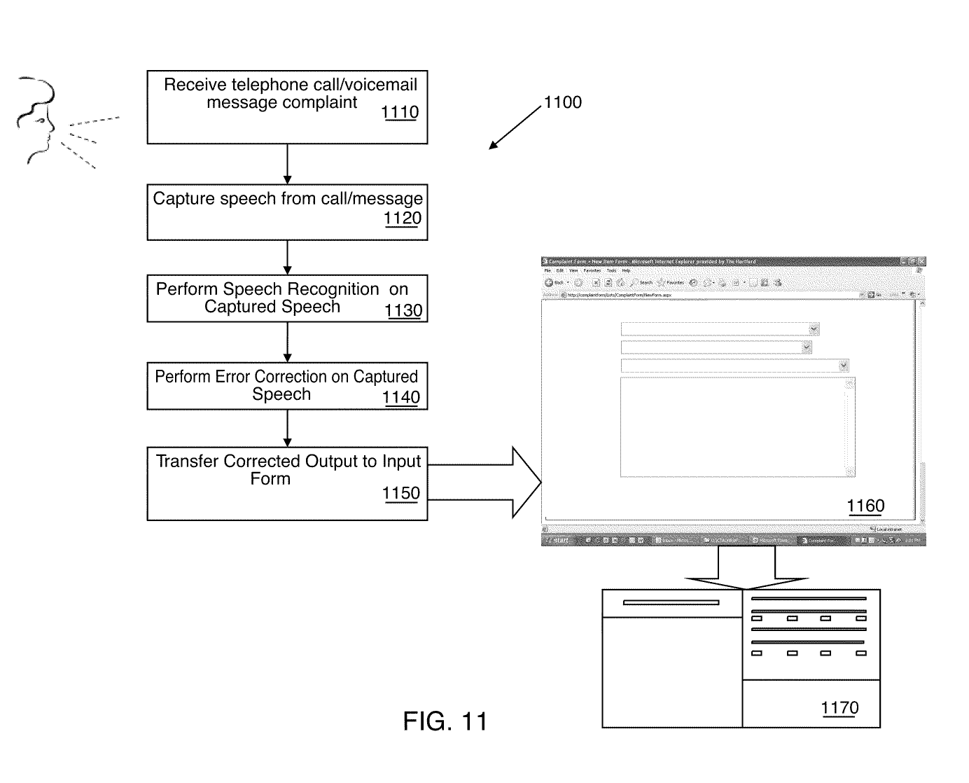

With additional reference to FIGS. 4-7, the present invention provides for intelligent automatic prefill or suggestion of data of one or more of the input fields shown in forms 404-702 respectively as now shown in FIG. 8. Form 810 includes one or more form fields 820, 830, 840, 850 and 860 which are pre-populated or pre-filled using databases 870 and 880 and also through one or more intelligent processing techniques using a processing server 890 which may operate on certain provided information such as text string 894, which may be acquired through direct input or via a conversion process such as is shown in FIG. 11. A number of techniques are employed to intelligently pre-fill data such as artificial intelligence, historical data mining and predictive modeling to assist in the intelligent form prefill. For example, in a data mining process, the system identifies patterns in the historical system data where the system data is analyzed across multiple dimensions and correlations to the presently available information 894 to provide better form input prediction. For example, based on information provided in one or more input fields such as in field 630 of FIG. 6, other fields may be intelligently pre-filled such as fields 610 and 620 and vice versa. In one embodiment utilizing predictive modeling for intelligent form pre-fill, the system builds a model of past complaint related behavior information based on the patterns and correlations stored from past completed form data.

Additionally, one or more third party data sources may be implemented to pre-fill or suggest data for one or more of the form input fields. For example, certain address data may be intelligently pre-filled for one or more external or internal databases such as shown as database server 230 in FIG. 2. Data pre-fill may be implemented via a “push” information flow model in which when a new form is initiated by a user with one or more inputs, one or more other input fields are automatically provided in the form. In another embodiment, the system implements a “pull” information flow model, in which input fields are only obtained by the characterization module from the database(s) when they are requested by a user.

FIG. 9 is a block diagram of an embodiment of a workers compensation complaint intake, tracking and processing system 900 in accordance with some embodiments of the invention. As described with respect to FIG. 9, the workers compensation complaint intake, tracking and processing system 900 may receive workers compensation related complaints 910 from one or more participants. For example, workers compensation complaint intake, tracking and processing system 900 might include a messaging server 912 to send and receive text messages, voicemails, emails and attachments from participants. As discussed earlier herein, emails may include reminder emails related to resolution milestones and workflows. Workers compensation complaint intake, tracking and processing system 900 may include a web server 914 to access web sites or links and/or to receive information submitted via a web site associated with the system 900. Complaint intake, tracking and processing system 900 may include a facsimile machine 916 to receive insurance complaint documents over the public switched telephone network or other communication network. According to some embodiments, the complaint intake, tracking and processing system 900 further includes one or more scanners 918 that can create electronic image files from paper documents.

According to some embodiments, the complaint intake, tracking and processing system 900 further includes a converter 920. Converter 920 might comprise, for example, an image format converter that translates data from a first format to a second format (e.g., a bitmap image to a PDF format). Converter 920 might also comprise, for example, an optical character recognition application that converts some or all of an image file into text information. Note that converter 920 might convert any type of document into any other type of document (e.g., a spreadsheet document might be converted to a word processing or HTML format).

The complaint intake, tracking and processing system 900 may further include one or more identification data terminals 930 for display and manipulation of one or more of the complaint documents, including assignment of identification data to the complaint documents.

Complaint intake, tracking and processing system 900 may further include one or more databases 950 to store the complaint related image information and associated tracking and identification data. Information from the databases 950 may then be transmitted to and/or accessed by other devices. For example, a scanned PDF image file in the database 950 (and a manually entered complainant name and address associated with that image file) might be transmitted to a workers compensation vendor system.

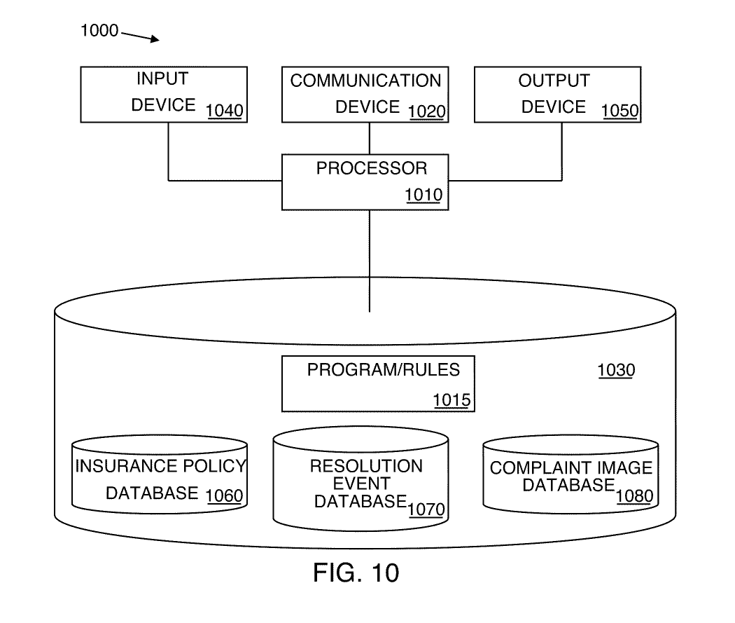

FIG. 10 illustrates a complaint processing module 1000 that might be descriptive, for example, of the complaint processing module 240 illustrated in FIG. 2 in accordance with an exemplary embodiment of the invention. The complaint processing module 1000 intelligently identifies and tracks a complaint submitted to the insurance company. Complaint processing module 1000 comprises a processor 1010, such as one or more INTEL® Pentium® processors, coupled to a communication device 1020 configured to communicate via a communication network (not shown in FIG. 10). The communication device 1020 may be used to communicate, for example, with one or more remote complaint participant devices, complaint document conversion systems, review systems, complaint processor devices and/or the respective Department of Insurance/workers compensation offices.

Processor 1010 is also in communication with an input device 1040. The input device 1040 may comprise, for example, a keyboard, a mouse, or computer media reader. Such an input device 1040 may be used, for example, to enter and access information about complaint documents and/or complaint validation rules. The processor 1010 is also in communication with an output device 1050. The output device 1050 may comprise, for example, a modem, a network port, display screen or printer. Such an output device 1050 may be used, for example, to provide reports and/or display information associated with certain complaints. According to some embodiments, processor 1010 may transmit, via communication device 1020, an indication of the insurance complaint document image along with resolution event information for review and complaint resolution processing.

Processor 1010 is also in communication with a storage device 1030. The storage device 1030 may comprise any appropriate information storage device, including combinations of magnetic storage devices (e.g., magnetic tape and hard disk drives), optical storage devices, and/or semiconductor memory devices such as Random Access Memory (RAM) devices and Read Only Memory (ROM) devices. Storage device 1030 stores a program/rules 1015 for controlling processor 1010. Processor 1010 performs instructions of program 1015, and thereby operates in accordance any embodiments of the present invention described herein. Program 1015 may contain instructions, routines and code for processing, tracking and validating complaints in the system. For example, processor 1010 may receive, via the communication device 1020, an insurance complaint document image and associated complaint data. Processor 1010 may also match the complaint data with certain resolution information such as certain follow ups or milestones to be performed with respect to resolution of the complaint. For example, a certain regulation, treatment file or insurance record may have to be checked with relation to the complaint. Moreover, processor 1010 may match this information using one or more techniques, rules or formulas provided in program 1015. For example, matching or correlating the complaint data with validation and/or resolution information may be performed using deterministic, probabilistic, fuzzy, phonetic, and transliterative techniques, knowledge-based expertise and advanced heuristic algorithms and/or combinations thereof.

As shown in FIG. 10, the storage device 1030 also stores an workers compensation insurance policy database 1060, a complaint resolution event database 1070, and a complaint document image database 1080. Insurance policy database 1060 may store information about underlying policies related to the complaint as well as employer/employer and vendor related information. Complaint resolution event database 1070 may store information about progress and/or resolution information related to each complaint. Complaint document image database 1080 may store electronic representations of documents and images that relate to the complaints received. The illustrations and accompanying descriptions of the databases presented herein are exemplary, and any number of other database arrangements could be employed besides those suggested by the figures.

FIG. 11 illustrates a method 1100 of the present invention for intaking and tracking voice based workers compensation complaints. In this embodiment, a telephone call or voice mail message is received related to a workers compensation complaint, such as an injured worker calling the insurance company to complain about the quality of care they recently received for their injury, step 1110. At step 1120, the speech from the call or voice mail message is captured for processing.

At step 1130, the speech recognition process starts with automatic speech recognition of the captured speech to produce a text based version of the captures speech. At step 1140, error correction is performed on the processed speech to remove any inconsistencies and other errors in the processed speech. At step 1150, the input form 1160 is then populated with corrected speech output. For example, when the caller introduced themselves and provides their address, the input form 1160 may be populated with such information in the appropriate fields. Alternatively the text can be sent by fax, text message, electronic mail message such as via messaging server 912 of FIG. 9 to the insurance company and/or vendor. The results of the speech processing is then stored such as in database 950 of FIG. 9 as a historical record for later retrieval.

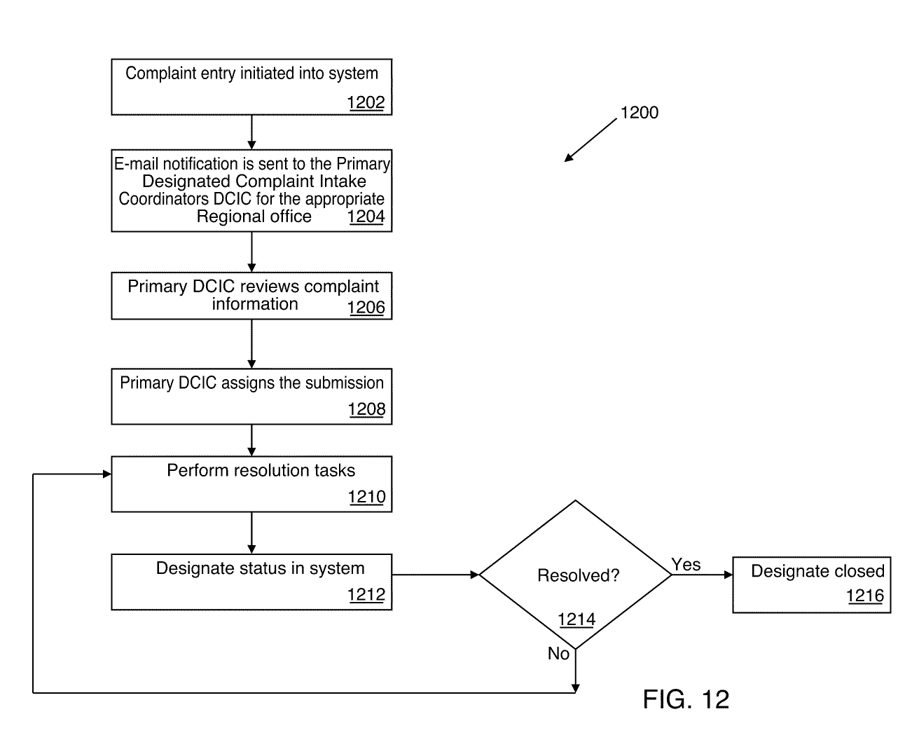

FIG. 12 illustrates an exemplary resolution workflow method 1200 of the present invention for intaking and resolving workers compensation complaints. At step 1202, a complaint entry is initiated for completing a workers compensation intake form of the present invention. At step 1204 a message, such as an electronic mail message is generated to the primary DCIC for a certain regional office. At step 1206, the complaint is reviewed by the primary DCIC, At step 1208 the primary DCIC assigns the submission based on availability and/or expertise to a complain handler or other DCIC for follow up or resolution. At step 1210, certain resolution tasks are performed which may include tasks such as drafting a letter to the complainant, investigating the complaint, and/or contacting a vendor such as a doctor or therapist associated with the complainant. At step 1212, the status of the complaint is designated in the system. The primary DCIC and the system may determine whether the complaint is resolved at step 1214 and if so, the complaint is designated as closed at step 1216. If not resolved, additional resolution tasks are performed at step 1210.

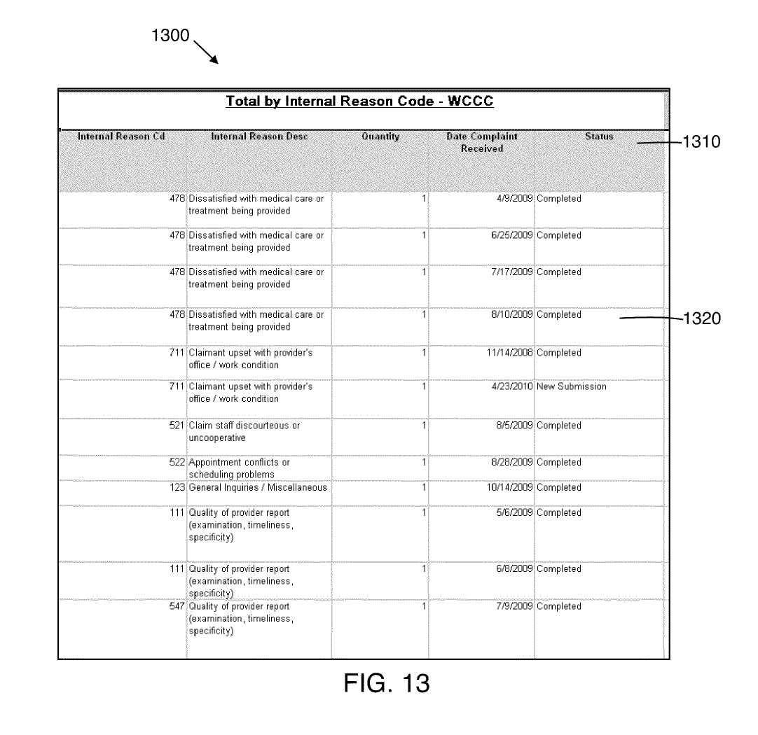

FIG. 13 illustrates an exemplary report 1300 generated in accordance with the present invention. The illustrative report 1300 includes a plurality of rows, such as rows and columns 1310 and 1320 which include information about the workers compensation complaints such as certain descriptions, types dates and resolution status information. Intelligent reporting module 244 shown in FIG. 2 may be used to generate such reports to manage and track the progress of various complaints and the associated resolution activities related to the complaints. Such reports may be used for both internal and regulatory compliance, such as for the compliance with internal response timeframes and/or regulatory timeframes for the follow-up and/or resolution of the complaints. Generally, the generated reports can be customized to the needs of a DCIC, vendor or other personnel and can include any information and/or statistics produced by the system 200 shown in FIG. 2.

The following illustrates various additional embodiments of the invention. These do not constitute a definition of all possible embodiments, and those skilled in the art will understand that the present invention is applicable to many other embodiments. Further, although the following embodiments are briefly described for clarity, those skilled in the art will understand how to make any changes, if necessary, to the above-described apparatus and methods to accommodate these and other embodiments and applications.

Although specific hardware and data configurations have been described herein, not that any number of other configurations may be provided in accordance with embodiments of the present invention (e.g., some of the information associated with the databases described herein may be combined or stored in external systems).

What is claimed:

1. A workers compensation complaint tracking system for facilitating resolution of workers compensation related complaints comprising:
a server comprising a processor, and a storage device;
a complaint intake module configured for workers compensation related complaint data input, the complaint intake module providing a dynamic intake form for receiving and capturing complaint data from a user and storing said data in said storage device;
a validation engine module for validating the complaint information in conjunction with a one or more complaint validation rules; and
a reporting module configured to furnish reports of the validated complaints for both regulatory compliance and internal insurance company guidelines;
wherein each of said modules is implemented on the server for access by one or more users.

2. The workers compensation complaint tracking system of claim 1, wherein the complaint intake module includes a speech to text conversion processor.

3. The workers compensation complaint tracking system of claim 1, wherein the complaint intake module performs pre-filling of the dynamic intake form using a predictive model based on historical workers compensation related complaint information.

4. The workers compensation complaint tracking system of claim 1, further comprising a display screen, wherein the dynamic intake form provides pre-defined selections of workers compensation related information to the user via the display screen.

5. The workers compensation complaint tracking system of claim 4, wherein the pre-defined selections of workers compensation related information relate to at least one of an address, a claim number and a category of complaint.

6. The workers compensation complaint tracking system of claim 1, wherein the complaint intake module is coupled to an automatic speech recognition module for converting telephone based communications to text for input to one or more input fields in the dynamic form.

7. The workers compensation complaint tracking system of claim 1, wherein pre-filling of the workers compensation related information is performed using a third party database concurrent with receiving complaint data from the user.

8. The workers compensation complaint tracking system of claim 1, further comprising a communications interface including an electronic mail server configured to deliver electronic mail message at resolution milestones related to the complaint.

9. The workers compensation complaint tracking system of claim 1, wherein the validation module determines if the complaint originates directly from a regulatory agency.

10. The workers compensation complaint tracking system of claim 1, further comprising a tracking module for generating a voice based reminder message based on one or more of the input fields in the dynamic form.

11. A workers compensation complaint processing system comprising:
a communication device for receiving and transmitting workers compensation related complaint information via a communication network;
a processor coupled to the communication device for processing complaint related information; and
a storage device in communication with said processor and storing instructions adapted to be executed by said processor to:
provide a complaint input form via the communication device for receiving complaint related information;
process complaint related information to produce insurance complaint data in an electronic data format;
store the insurance complaint data in the electronic data format;
validate the insurance complaint data with one or more validation rules,
augment the validated insurance complaint data with additional data associated with at least a portion of the insurance complaint data; and
transmit at least one status message related to the complaint related information.

12. The workers compensation complaint processing system of claim 11, wherein validating the complaint document comprises determining if the complaint information is related to a direct regulatory complaint.

13. The workers compensation complaint processing system of claim 11, wherein augmenting the data comprises accessing one or more third party databases for complaint related information.

14. The workers compensation complaint processing system of claim 11, wherein processing the insurance complaint information into an electronic data format comprises performed error corrected speech to text translation.

15. The workers compensation complaint processing system of claim 11, wherein the status message is an electronic mail message to a workers compensation related vendor.

16. The workers compensation complaint processing system of claim 11, wherein the status message is a voicemail message to an insurance company employee including information related to the complaint.

17. A computer-readable medium storing instructions adapted to be executed by a processor to perform an insurance complaint processing method in a workers compensation complaint tracking system, said method comprising:
receiving workers compensation complaint information via an intelligent web form rendered on a communication device,
validating the complaint information based on one or more business rules to determine if the complaint information qualifies for tracking;
augmenting the validated complaint information in the intelligent web form with data related to the complaint information;
tracking resolution progress of the complaint based on date based milestones in the intelligent web form; and
transmitting an electronic indication of the resolution progress to at least one other communication device.

18. The computer-readable medium of claim 17, wherein the method further comprises:
receiving incremental resolution information related to the complaint from one or more remote communication devices.

18. The computer-readable medium of claim 17, wherein the method further comprises:
establishing a baseline timestamp upon first receiving insurance complaint information via the intelligent web form, the timestamp relating to the resolution progress of the complaint.

19. A computerized method for processing workers compensation related complaints, the method comprising:
receiving, via an electronic intake interface, verbal insurance complaint information via an automated speech to text facility for populating one or more dynamic input fields of an intelligent web form having a plurality of dynamic input fields rendered on a communication device,
populating, via a processing interface, one or more additional fields of the dynamic input fields based on one or more of historical complaint related data and employer policy data; and
generating, via a communications interface, one or more electronic reminder messages related to resolution progress of the complaint.

20. The computerized method of claim 19, further comprising:
correlating, via the processing interface, one or more of the dynamic input fields with one or more resolution tasks for resolution of the complaint.
